(19) United States
(12) Patent Application Publication
(10) Pub. No.: US 2022/0153947 A1
(43) Pub. Date: May 19, 2022

(54) BLOWING AGENTS FOR EXTRUDED POLYSTYRENE FOAM AND EXTRUDED POLYSTYRENE FOAM AND METHODS OF FOAMING

(71) Applicant: HONEYWELL INTERNATIONAL INC., Charlotte, NC (US)

(72) Inventors: Josep GIMENO, Charlotte, NC (US); Ryan HULSE, Charlotte, NC (US); Syed Hassan MAHMOOD, Charlotte, NC (US)

(73) Assignee: HONEYWELL INTERNATIONAL INC., Charlotte, NC (US)

(21) Appl. No.: 17/527,787

(22) Filed: Nov. 16, 2021

Related U.S. Application Data
(60) Provisional application No. 63/114,948, filed on Nov. 17, 2020.
(60) Provisional application No. 63/181,135, filed on Apr. 28, 2021.

(51) Int. Cl. C08J 9/12; C08J 9/14

(52) U.S. Cl. CPC C08J 9/127; C08J 9/146; C08J 9/142; C08J 9/141; C08J 2325/06; C08J 2203/202; C08J 2203/142; C08J 2203/12; C08J 2203/02; C08J 9/122

(57) ABSTRACT

Methods, foams and blowing agents for producing thermoplastic foam having low aged lambda and low foam density, wherein the blowing agent comprises: (a) from about 50% by weight to about 70% by weight of an HFO and/or an HFCO having three atoms; (b) a first co-blowing agent consisting essentially of from about 2% to about 15% by weight of methyl formate; (c) a second co-blowing agent consisting essentially of from about 20% to about 30% by weight of dimethyl ether, isobutane and combinations of these; and (d) a third co-blowing agent consisting essentially of from about 2% to about 25% by weight of carbon dioxide, acetone and combinations of these.

### CROSS REFERENCE TO RELATED APPLICATIONS

This invention relates to and claims the priority benefit of U.S. Provisional Application No. 63/114,948, filed Nov. 17, 2020 and U.S. Provisional Application No. 63/181,135, filed Apr. 28, 2021, each of which is incorporated herein by reference in its entirety.

### FIELD OF THE INVENTION

This invention relates to compositions, methods and systems having utility in connection with extruded thermoplastic foams, including particularly in connection with blowing agents, foamable compositions, foams and articles made with or from foams.

### BACKGROUND

Certain fluorocarbon fluids have found widespread use as blowing agents. Because of environmental problems, including relatively high ozone depletion potentials, associated with the use of some of the fluorocarbon fluids that have heretofore been used in these applications, it has become increasingly desirable to use fluids having low or even zero ozone depletion potential, such as hydrofluorocarbons (“HFCs”). However, some HFC fluids may have relatively high global warming potentials associated therewith, and it is desirable to use hydrofluorocarbon or other fluorinated fluids having low ozone depletion potential and low global warming potential while maintaining the desired performance properties of the foam.

In terms of performance properties of the foam, it is considered important in many cases that the foam possess excellent thermal insulating properties and other desirable foam characteristics when used as blowing agents. Another foam characteristic that is important in many applications is the density of the foam. For example, there is a need in many thermal insulating foam applications to have a foam that not only exhibits a low thermal conductivity, but also a relatively low foam density.

There has thus been an increasing need for new blowing agent materials that are attractive alternatives to the compositions heretofore used as blowing agents in these and other applications. Applicants have thus recognized a need for new blowing agent compositions that offer effective alternatives to, and are considered environmentally safer substitutes for, previously used blowing agents to make low density, low thermal conductivity thermoplastic foams, and extruded polystyrene foam in particular.

The use of halogenated olefin blowing agents, including hydrofluoroolefins (HFOs) and hydrochlorofluoroolefins (HCFOs), is also known, as disclosed for example in US 2009/0305876, which is assigned to the assignee of the present invention and which is incorporated herein by reference.

Notwithstanding the disclosures in each of the '876, applicants have come to appreciate that an unexpected advantage can be achieved in connection with the formation of extruded thermoplastic foams, and in particular extruded polystyrene foams, by using a hydrofluoroolefin, particularly one or more HFOs and/or HFCOs having three or four carbons, such as trans-HFO-1234ze, trans-HCFO-1233zd and cis-1,1,1,4,4,4-hexafluorobut-2-ene (HFO-1336mzzm(Z)), in combination with a first co-blowing agent consisting of methyl formate, a second co-blowing agent consisting of isobutene and/or dimethyl ether, and at least a third blowing agent consisting of carbon dioxide and/or acetone, as explained in detail hereinafter.

### SUMMARY

The present invention includes blowing agents for producing thermoplastic foams with excellent thermal insulating properties (including preferably low aged lambda) and low foam density, said blowing agents comprising:

(a) from about 50% by weight to about 70% by weight of one or more HFOs three or four carbon atoms and/or an HFCOs having three or four carbon atoms;

(b) a first co-blowing agent consisting essentially of from about 5% to about 20% by weight of methyl formate, ethanol and combinations of these;

(c) a second co-blowing agent consisting essentially of from about 20% to about 40% by weight of dimethyl ether, isobutane and combinations of these; and

(d) a third co-blowing agent consisting essentially of from about 2% to about 5% by weight of carbon dioxide, provided the total of (a), (b), (c) and (d) comprises at least about 90% by weight of the blowing agent. For the purposes of convenience, blowing agents in accordance with this paragraph are referred to herein as Blowing Agent 1A.

The present invention includes blowing agents for producing thermoplastic foams with excellent thermal insulating properties (including preferably low aged lambda) and low foam density, said blowing agents comprising:

(a) from about 50% by weight to about 70% by weight of one or more HFOs three or four carbon atoms and/or an HFCOs having three or four carbon atoms;

(b) a first co-blowing agent consisting essentially of from about 5% to about 20% by weight of methyl formate, ethanol and combinations of these;

(c) a second co-blowing agent consisting essentially of from about 20% to about 40% by weight of dimethyl ether, isobutane and combinations of these; and

(d) a third co-blowing agent consisting essentially of from about 2% to about 5% by weight of carbon dioxide, provided the total of (a), (b), (c) and (d) comprises at least about 95% by weight of the blowing agent. For the purposes of convenience, blowing agents in accordance with this paragraph are referred to herein as Blowing Agent 1B.

The present invention includes blowing agents for producing thermoplastic foams with excellent thermal insulating properties (including preferably low aged lambda) and low foam density, said blowing agents comprising:

(a) from about 50% by weight to about 70% by weight of one or more HFOs three or four carbon atoms and/or an HFCOs having three or four carbon atoms;

(b) a first co-blowing agent consisting essentially of from about 5% to about 20% by weight of methyl formate, ethanol and combinations of these;

(c) a second co-blowing agent consisting essentially of from about 20% to about 40% by weight of dimethyl ether, isobutane and combinations of these; and

(d) a third co-blowing agent consisting essentially of from about 2% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 1C.

The present invention also includes blowing agents for producing thermoplastic foams with excellent thermal insulating properties (including preferably low aged lambda) and low foam density, said blowing agents comprising:

(a) from about 50% by weight to about 65% by weight of an HFO and/or an HFCO having three or four carbon atoms;

(b) a first co-blowing agent consisting essentially of from about 5% to about 15% by weight of methyl formate, ethanol and combinations of these;

(c) a second co-blowing agent consisting essentially of from about 20% to about 35% by weight of dimethyl ether, isobutane and combinations of these; and

(d) a third co-blowing agent consisting essentially of less than about 5% by weight of carbon dioxide. For the purposes of convenience, blowing agents in accordance with this paragraph are referred to herein as Blowing Agent 2A.

The present invention also includes blowing agents for producing thermoplastic foams with excellent thermal insulating properties (including preferably low aged lambda) and low foam density, said blowing agents comprising:

(a) from about 50% by weight to about 65% by weight of an HFO and/or an HFCO having three or four carbon atoms;

(b) a first co-blowing agent consisting essentially of from about 5% to about 15% by weight of methyl formate, ethanol and combinations of these;

(c) a second co-blowing agent consisting essentially of from about 20% to about 35% by weight of dimethyl ether, isobutane and combinations of these; and

(d) a third co-blowing agent consisting essentially of less than 5% by weight of carbon dioxide. For the purposes of convenience, blowing agents in accordance with this paragraph are referred to herein as Blowing Agent 2B.

The present invention also includes blowing agents for producing thermoplastic foams with excellent thermal insulating properties (including preferably low aged lambda) and low foam density, said blowing agents comprising:

(a) from about 55% by weight to about 65% by weight of 1234ze(E);

(b) about 5% to about 15% by weight of methyl formate;

(c) about 20% to about 25% by weight of dimethyl ether, isobutane and combinations of these; and

(d) about 3% to about 5% by weight of carbon dioxide. For the purposes of convenience, blowing agents in accordance with this paragraph are referred to herein as Blowing Agent 3A.

The present invention also includes blowing agents for producing thermoplastic foams with excellent thermal insulating properties (including preferably low aged lambda) and low foam density, said blowing agents comprising:

(a) from about 55% by weight to about 65% by weight of 1234ze(E);

(b) a first co-blowing agent consisting essentially of from about 5% to about 15% by weight of methyl formate;

(c) a second co-blowing agent consisting essentially of from about 20% to about 25% by weight of dimethyl ether and combinations of these; and

(d) a third co-blowing agent consisting essentially of from about 3% to about 5% by weight of carbon dioxide. For the purposes of convenience, blowing agents in accordance with this paragraph are referred to herein as Blowing Agent 3B.

The present invention also includes blowing agents for producing thermoplastic foams with excellent thermal insulating properties (including preferably low aged lambda) and low foam density, said blowing agents comprising:

(a) from about 55% by weight to about 65% by weight of 1234ze(E);

(b) a first co-blowing agent consisting essentially of from about 5% to about 15% by weight of methyl formate;

(c) a second co-blowing agent consisting essentially of from about 20% to about 25% by weight of dimethyl ether and combinations of these; and

(d) a third co-blowing agent consisting essentially of from about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 3C.

The present invention also includes blowing agents for producing thermoplastic foams with excellent thermal insulating properties (including preferably low aged lambda) and low foam density, said blowing agents comprising:

(a) from about 45% by weight to about 65% by weight of 1234ze(E), 1233zd(E) and combinations of these;

(b) a first co-blowing agent consisting essentially of from about 5% to about 15% by weight of methyl formate, ethanol or combinations of these;

(c) a second co-blowing agent consisting essentially of from about 25% to about 40% by weight of dimethyl ether, isobutane and combinations of these; and

(d) a third co-blowing agent consisting essentially of from about 3% to about 5% by weight of carbon dioxide. For the purposes of convenience, blowing agents in accordance with this paragraph are referred to herein as Blowing Agent 4A1.

The present invention also includes blowing agents for producing thermoplastic foams with excellent thermal insulating properties (including preferably low aged lambda) and low foam density, said blowing agents comprising:

(a) from about 45% by weight to about 65% by weight of 1234ze(E), 1233zd(E) and combinations of these;

(b) a first co-blowing agent consisting essentially of from about 5% to about 15% by weight of methyl formate, ethanol or combinations of these;

(c) a second co-blowing agent consisting essentially of from about 25% to about 40% by weight of dimethyl ether, isobutane and combinations of these; and

(d) a third co-blowing agent consisting essentially of from about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 4A2.

The present invention also includes blowing agents for producing thermoplastic foams with excellent thermal insulating properties (including preferably low aged lambda) and low foam density, said blowing agents comprising:

(a) from about 45% by weight to about 65% by weight of 1234ze(E), 1233zd(E) and combinations of these;

(b) a first co-blowing agent consisting essentially of from about 5% to about 15% by weight of methyl formate;

(c) a second co-blowing agent consisting essentially of from about 25% to about 40% by weight of isobutane and combinations of these; and

(d) a third co-blowing agent consisting essentially of from about 3% to about 5% by weight of carbon dioxide. For the purposes of convenience, blowing agents in accordance with this paragraph are referred to herein as Blowing Agent 4B.

The present invention also includes blowing agents for producing thermoplastic foams with excellent thermal insulating properties (including preferably low aged lambda) and low foam density, said blowing agents comprising:

(a) from about 45% by weight to about 65% by weight of 1234ze(E), 1233zd(E) and combinations of these;

(b) a first co-blowing agent consisting essentially of from about 5% to about 15% by weight of methyl formate;

(c) a second co-blowing agent consisting essentially of from about 30% to about 40% by weight of isobutane and combinations of these; and

(d) a third co-blowing agent consisting essentially of from about 3% to about 5% by weight of carbon dioxide. For the purposes of convenience, blowing agents in accordance with this paragraph are referred to herein as Blowing Agent 4C.

The present invention also includes blowing agents for producing thermoplastic foams with excellent thermal insulating properties (including preferably low aged lambda) and low foam density, said blowing agents comprising:

(a) from about 50% by weight to about 60% by weight of 1234ze(E), 1233zd(E) and combinations of these;

(b) a first co-blowing agent consisting essentially of from about 5% to about 15% by weight of ethanol;

(c) a second co-blowing agent consisting essentially of from about 25% to about 40% by weight of isobutane and combinations of these; and

(d) a third co-blowing agent consisting essentially of from about 3% to about 5% by weight of carbon dioxide. For the purposes of convenience, blowing agents in accordance with this paragraph are referred to herein as Blowing Agent 4D.

The present invention also includes blowing agents for producing thermoplastic foams with excellent thermal insulating properties (including preferably low aged lambda) and low foam density, said blowing agents comprising:

(a) from about 50% by weight to about 60% by weight of 1234ze(E), 1233zd(E) and combinations of these;

(b) a first co-blowing agent consisting essentially of from about 5% to about 15% by weight of ethanol;

(c) a second co-blowing agent consisting essentially of from about 25% to about 35% by weight of isobutane and combinations of these; and

(d) a third co-blowing agent consisting essentially of from about 3% to about 5% by weight of carbon dioxide. For the purposes of convenience, blowing agents in accordance with this paragraph are referred to herein as Blowing Agent 4E1.

The present invention also includes blowing agents for producing thermoplastic foams with excellent thermal insulating properties (including preferably low aged lambda) and low foam density, said blowing agents comprising:

(a) from about 50% by weight to about 60% by weight of 1234ze(E), 1233zd(E) and combinations of these;

(b) a first co-blowing agent consisting essentially of from about 5% to about 15% by weight of ethanol;

(c) a second co-blowing agent consisting essentially of from about 25% to about 35% by weight of isobutane and combinations of these; and

(d) a third co-blowing agent consisting essentially of from about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 4E2.

The present invention also includes blowing agents for producing thermoplastic foams with excellent thermal insulating properties (including preferably low aged lambda) and low foam density, said blowing agents comprising:

(a1) from about 30% by weight to about 50% by weight of 1234ze(E);

(a2) from about 10% by weight to about 20% by weight of 1233zd(E);

(b) about 5% to about 20% by weight of methyl formate, ethanol or combinations of these;

(c) about 20% to about 40% by weight of dimethyl ether, isobutane and combinations of these; and

(d) about 3% to about 5% by weight of carbon dioxide. For the purposes of convenience, blowing agents in accordance with this paragraph are referred to herein as Blowing Agent 4F1.

The present invention also includes blowing agents for producing thermoplastic foams with excellent thermal insulating properties (including preferably low aged lambda) and low foam density, said blowing agents comprising:

(a1) from about 30% by weight to about 50% by weight of 1234ze(E);

(a2) from about 10% by weight to about 20% by weight of 1233zd(E);

(b) about 5% to about 20% by weight of methyl formate, ethanol or combinations of these;

(c) about 20% to about 40% by weight of dimethyl ether, isobutane and combinations of these; and

(d) about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 4F2.

The present invention also includes blowing agents for producing thermoplastic foams with excellent thermal insulating properties (including preferably low aged lambda) and low foam density, said blowing agents comprising:

(a1) from about 30% by weight to about 50% by weight of 1234ze(E);

(a2) from about 10% by weight to about 20% by weight of 1233zd(E);

(b) about 5% to about 20% by weight of methyl formate;

(c) about 20% to about 40% by weight of isobutane; and

(d) about 3% to about 5% by weight of carbon dioxide. For the purposes of convenience, blowing agents in accordance with this paragraph are referred to herein as Blowing Agent 4G1.

The present invention also includes blowing agents for producing thermoplastic foams with excellent thermal insulating properties (including preferably low aged lambda) and low foam density, said blowing agents comprising:

(a1) from about 30% by weight to about 50% by weight of 1234ze(E);

(a2) from about 10% by weight to about 20% by weight of 1233zd(E);

(b) about 5% to about 20% by weight of methyl formate;

(c) about 20% to about 40% by weight of isobutane; and

(d) about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 4G2.

The present invention also includes blowing agents for producing thermoplastic foams with excellent thermal insulating properties (including preferably low aged lambda) and low foam density, said blowing agents comprising:

(a1) about 40% by weight of 1234ze(E);

(a2) about 13% by weight of 1233zd(E);

(b) about 10% by weight of methyl formate;

(c) about 33% by weight of isobutane; and

(d) from about 3% to about 5% by weight of carbon dioxide. For the purposes of convenience, blowing agents in accordance with this paragraph are referred to herein as Blowing Agent 4H.

The present invention also includes blowing agents for producing thermoplastic foams with excellent thermal insulating properties (including preferably low aged lambda) and low foam density, said blowing agents comprising:

(a1) from about 30% by weight to about 50% by weight of 1234ze(E);

(a2) from about 10% by weight to about 20% by weight of 1233zd(E);

(b) about 5% to about 15% by weight of ethanol;

(c) about 30% to about 40% by weight of isobutane; and

(d) about 3% to about 5% by weight of carbon dioxide. For the purposes of convenience, blowing agents in accordance with this paragraph are referred to herein as Blowing Agent 411.

The present invention also includes blowing agents for producing thermoplastic foams with excellent thermal insulating properties (including preferably low aged lambda) and low foam density, said blowing agents comprising:

(a1) from about 30% by weight to about 50% by weight of 1234ze(E);

(a2) from about 10% by weight to about 20% by weight of 1233zd(E);

(b) about 5% to about 15% by weight of ethanol;

(c) about 30% to about 40% by weight of isobutane; and

(d) about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 412.

The present invention also includes blowing agents for producing thermoplastic foams with excellent thermal insulating properties (including preferably low aged lambda) and low foam density, said blowing agents comprising:

(a1) about 30% by weight to about 50% by weight of 1234ze(E);

(a2) about 10% by weight to about 20% by weight of 1233zd(E);

(b) about 5% to about 10% by weight of ethanol;

(c) about 30% to about 40% by weight of isobutane; and

(d) from about 3% to about 5% by weight of carbon dioxide. For the purposes of convenience, blowing agents in accordance with this paragraph are referred to herein as Blowing Agent 4J1.

The present invention also includes blowing agents for producing thermoplastic foams with excellent thermal insulating properties (including preferably low aged lambda) and low foam density, said blowing agents comprising:

(a1) about 30% by weight to about 50% by weight of 1234ze(E);

(a2) about 10% by weight to about 20% by weight of 1233zd(E);

(b) about 5% to about 10% by weight of ethanol;

(c) about 30% to about 40% by weight of isobutane; and

(d) from about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 4J2.

The present invention also includes blowing agents for producing thermoplastic foams with excellent thermal insulating properties (including preferably low aged lambda) and low foam density, said blowing agents comprising:

(a1) about 41.5% by weight of 1234ze(E);

(a2) about 10% by weight of 1233zd(E);

(b) about 7% by weight of ethanol;

(c) about 35% by weight of isobutane; and

(d) about 3% to about 5% by weight of carbon dioxide. For the purposes of convenience, blowing agents in accordance with this paragraph are referred to herein as Blowing Agent 4K1.

The present invention also includes blowing agents for producing thermoplastic foams with excellent thermal insulating properties (including preferably low aged lambda) and low foam density, said blowing agents comprising:

(a1) about 41.5% by weight of 1234ze(E);

(a2) about 10% by weight of 1233zd(E);

(b) about 7% by weight of ethanol;

(c) about 35% by weight of isobutane; and

(d) about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 4K2.

The present invention also includes blowing agents for producing thermoplastic foams with excellent thermal insulating properties (including preferably low aged lambda) and low foam density, said blowing agents comprising:

(a1) about 30% by weight to about 50% by weight of 1234ze(E);

(a2) about 10% by weight to about 20% by weight of 1233zd(E);

(b) about 7% to about 15% by weight of ethanol;

(c) about 30% to about 40% by weight of isobutane; and

(d) from about 3% to about 5% by weight of carbon dioxide. For the purposes of convenience, blowing agents in accordance with this paragraph are referred to herein as Blowing Agent 4L1.

The present invention also includes blowing agents for producing thermoplastic foams with excellent thermal insulating properties (including preferably low aged lambda) and low foam density, said blowing agents comprising:

(a1) about 30% by weight to about 50% by weight of 1234ze(E);

(a2) about 10% by weight to about 20% by weight of 1233zd(E);

(b) about 7% to about 15% by weight of ethanol;

(c) about 30% to about 40% by weight of isobutane; and

(d) from about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 4L2.

The present invention also includes blowing agents for producing thermoplastic foams with excellent thermal insulating properties (including preferably low aged lambda) and low foam density, said blowing agents comprising:

(a1) about 40% by weight of 1234ze(E);

(a2) about 13% by weight of 1233zd(E);

(b) about 10% by weight of ethanol;

(c) about 33% by weight of isobutane; and

(d) about 3% to about 5% by weight of carbon dioxide. For the purposes of convenience, blowing agents in accordance with this paragraph are referred to herein as Blowing Agent 4M.

The present invention also includes blowing agents for producing thermoplastic foams with excellent thermal insulating properties (including preferably low aged lambda) and low foam density, said blowing agents comprising:

(a) from about 45% by weight to about 65% by weight of 1233zd(E);

(b) from about 5% to about 15% by weight of methyl formate;

(c) from about 15% to about 35% by weight of isobutane; and

(d) from about 3% to about 5% by weight of carbon dioxide. For the purposes of convenience, blowing agents in accordance with this paragraph are referred to herein as Blowing Agent 5A1.

The present invention also includes blowing agents for producing thermoplastic foams with excellent thermal insulating properties (including preferably low aged lambda) and low foam density, said blowing agents comprising:

(a) from about 45% by weight to about 65% by weight of 1233zd(E);

(b) from about 5% to about 15% by weight of methyl formate;

(c) from about 15% to about 35% by weight of isobutane; and

(d) from about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 5A2.

The present invention also includes blowing agents for producing thermoplastic foams with excellent thermal insulating properties (including preferably low aged lambda) and low foam density, said blowing agents comprising:

(a) about 61.5% by weight of 1233zd(E);

(b) about 11.5% by weight of methyl formate;

(c) about 23% by weight of isobutane; and

(d) about 3% to about 5% by weight of carbon dioxide. For the purposes of convenience, blowing agents in accordance with this paragraph are referred to herein as Blowing Agent 5B.

The present invention also includes blowing agents for producing thermoplastic foams with excellent thermal insulating properties (including preferably low aged lambda) and low foam density, said blowing agents comprising:

(a) from about 45% by weight to about 65% by weight of 1234ze(E);

(b) from about 5% to about 15% by weight of methyl formate;

(c) from about 15% to about 35% by weight of isobutane; and

(d) from about 3% to about 5% by weight of carbon dioxide. For the purposes of convenience, blowing agents in accordance with this paragraph are referred to herein as Blowing Agent 6A1.

The present invention also includes blowing agents for producing thermoplastic foams with excellent thermal insulating properties (including preferably low aged lambda) and low foam density, said blowing agents comprising:

(a) from about 45% by weight to about 65% by weight of 1234ze(E);

(b) from about 5% to about 15% by weight of methyl formate;

(c) from about 15% to about 35% by weight of isobutane; and

(d) from about 3% to about 5% by weight of carbon dioxide, provided the total of (a), (b), (c) and (d) comprises at least about 97% by weight of the blowing agent. For the purposes of convenience, blowing agents in accordance with this paragraph are referred to herein as Blowing Agent 6A2.

The present invention also includes blowing agents for producing thermoplastic foams with excellent thermal insulating properties (including preferably low aged lambda) and low foam density, said blowing agents comprising:

(a) about 61.5% by weight of 1234ze(E);

(b) about 11.5% by weight of methyl formate;

(c) about 23% by weight of isobutane; and

(d) about 3% to about 5% by weight of carbon dioxide. For the purposes of convenience, blowing agents in accordance with this paragraph are referred to herein as Blowing Agent 6B.

The present invention also includes methods of forming foam that use the blowing agents of the present invention, including Blowing Agents 1-6, and the present invention also includes foams that contain and/or are made by methods that use the blowing agents of the present invention, including Blowing Agents 1-6, as explained in detail herein. As used herein, reference to a defined blowing agent or a range of defined blowing agents, such as Blowing Agents 1-6, includes all blowing agents so defined, including any numbered blowing agent that includes a suffix, such as Blowing Agent 2 meaning Blowing Agent 2A and Blowing Agent 2B, and such as Blowing Agent 6 meaning Blowing Agent 6A1, Blowing Agent 6A2 and 6B.

### BRIEF DESCRIPTION OF THE DRAWING

FIG. 1 is a schematic representation of an extrusion system and process according to one embodiment of the invention and according to the examples herein.

FIG. 2 is a chart showing test results from Comparative Examples 1A and 1B.

FIG. 3 is a chart showing test results from Example 1.

FIG. 4 is a chart showing test results from Example 2.

FIG. 5 is a chart showing test results from Example 3.

FIG. 6A is a chart showing test results from Example 6(A).

FIG. 6B is a chart showing test results from Example 6(B).

### DEFINITIONS

1234ze means 1,1,1,3-tetrafluoropropene, without limitation as to isomeric form.

Trans1234ze and 1234ze(E) each mean trans1,3,3,3-tetrafluoropropene.

1234yf means 2,3,3,3-tetrafluoropropene.

1233zd means 1-chloro-3,3,3-trifluoropropene, without limitation as to isomeric form.

trans1233zd and 1233zd(E) each means trans1-chloro-3,3,3-trifluoropropene.

cis1224yd means cis1-chloro-2,3,3,3-tetrafluoropropane.

Cis1336mzz and 1336mzz(Z) each mean cis-1,1,1,4,4,4-hexafluorobutene, without limitation as to isomeric form.

Trans1336mzz and 1336mzz(E) each mean trans1,1,1,4,4,4-hexafluorobutene.

Methyl formate means the following compound

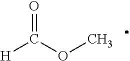

Methylal means dimethoxymethane ((CH3O)2CH2).

Dimethyl ether means the following compound—

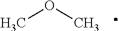

Isobutane and iC4 and isoC4 each mean 2-methyl propane.

Ethanol and EtOH each mean CH₃CH₂OH.

Closed cell foam means that a substantial volume percentage of the cells in the foam are closed, for example, about 20% by volume or more.

PS PEF homopolymer means a polymer having at least 99% by weight of ethylene furanoate moieties.

PEF copolymer means a polymer having at least 50% by weight of ethylene furanoate moieties and more than 1% of polymer moieties other than ethylene.

Styrene moiety means the compounds having the structure

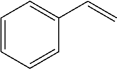

and all compounds in which one or more of the hydrogens are substituted.

Polystyrene, polystyrene resin, and PS each mean a polymer that is made from monomers that includes the styrene moiety, including homopolymers thereof, copolymers, and blends of polymers that include such homopolymers and/or copolymers.

XPS foam means polystyrene that has been formed into a foam in an extrusion process.

Aged thermal conductivity and aged lambda each means thermal conductivity measured as described in the examples.

Density means foam density as measured in the examples.

### DETAILED DESCRIPTION

### Blowing Agent

The blowing agent of the present invention, including each of Blowing Agents 1-6, may include one or more co-blowing agents other than those specified provided they are of a type and amount that does not impair the ability of the blowing agent to be used to form polystyrene foam, and in particular XPS foam, having the density and thermal conductivity properties described herein as aspects of the invention. Within this parameter, and by way of example only, the blowing agents of present blowing agent of the present invention, including each of Blowing Agents 1-6, may include, in addition to the specifically identified components of the blowing agent, one or more of the following: saturated hydrocarbons having 3 to 5 carbon atoms such as propane, normal butane, and cyclopentane, ethers such as ethyl ether, diethylether, and methyl ethyl ether, alkyl chlorides such as methyl chloride and ethyl chloride, alcohols such as methanol, propyl alcohol, isopropyl alcohol, butyl alcohol, sec-butyl alcohol, tert-butyl alcohol, aryl alcohol, crotyl alcohol, and propargyl alcohol, ketones and esters.

Other additives may also be included, again to the extent that the type and amount does not impair the ability of the blowing agent to be used to form polystyrene foam, and in particular XPS foam, having the density and thermal conductivity properties described herein as aspects of the invention. Within this parameter, and by way of example only, the blowing agents of present blowing agent of the present invention, including each of Blowing Agents 1-6, may include one or more of the following: processing aids, flame retardants, coloring agents, stabilizers, surfactants, polymer modifiers, toughening agents, colorants, dyes, solubility enhancers, rheology modifiers, plasticizing agents, flammability suppressants, antimicrobial agents, viscosity reduction modifiers, fillers, vapor pressure modifiers, nucleating agents, catalysts and the like.

### Foams

The present invention includes also thermoplastic foam, including and preferably XPS foam, comprising PS resin and a blowing agent of the present invention, including each of Blowing Agents 1-6.

The present invention includes XPS foam comprising:

(a) thermoplastic polymer cells comprising PS cell walls forming closed cells; and

(b) Blowing Agent 1 contained in the closed cells. For the purposes of convenience, foams in accordance with this paragraph are referred to herein as Foam 1.

The present invention includes XPS foam comprising:

(a) thermoplastic polymer cells comprising PS cell walls forming closed cells; and

(b) Blowing Agent 2 contained in the closed cells. For the purposes of convenience, foams in accordance with this paragraph are referred to herein as Foam 2.

The present invention includes XPS foam comprising:

(a) thermoplastic polymer cells comprising PS cell walls forming closed cells; and

(b) Blowing Agent 3 contained in the closed cells. For the purposes of convenience, foams in accordance with this paragraph are referred to herein as Foam 3.

The present invention includes XPS foam comprising:

(a) thermoplastic polymer cells comprising PS cell walls forming closed cells; and

(b) Blowing Agent 4 contained in the closed cells. For the purposes of convenience, foams in accordance with this paragraph are referred to herein as Foam 4.

The present invention includes XPS foam comprising:

(a) thermoplastic polymer cells comprising PS cell walls forming closed cells; and

(b) Blowing Agent 5 contained in the closed cells. For the purposes of convenience, foams in accordance with this paragraph are referred to herein as Foam 5.

The present invention includes XPS foam comprising:

(a) thermoplastic polymer cells comprising PS cell walls forming closed cells; and

(b) Blowing Agent 6 contained in the closed cells. For the purposes of convenience, foams in accordance with this paragraph are referred to herein as Foam 6.

The present invention includes XPS foam, including each of Foams 1-6, wherein the foam has a density of 36 kg/m3 or less and aged thermal conductivity of 32 mW/mk or less. For the purposes of convenience, foams in accordance with this paragraph are referred to herein as Foam 7A.

The present invention includes XPS foam, including each of Foams 1-6, wherein the foam has a density of 35 kg/m3 or less and aged thermal conductivity of 32 mW/mk or less. For the purposes of convenience, foams in accordance with this paragraph are referred to herein as Foam 7B.

The present invention includes XPS foam, including each of Foams 1-6, wherein the foam has a density of 34 kg/m3 or less and aged thermal conductivity of 32 mW/mk or less. For the purposes of convenience, foams in accordance with this paragraph are referred to herein as Foam 7C.

The present invention includes XPS foam, including each of Foams 1-6, wherein the foam has a density of 33 kg/m3 or less and aged thermal conductivity of 32 mW/mk or less. For the purposes of convenience, foams in accordance with this paragraph are referred to herein as Foam 7D.

The present invention includes XPS foam, including each of Foams 1-6, wherein the foam has a density of 32 kg/m3 or less and aged thermal conductivity of 32 mW/mk or less. For the purposes of convenience, foams in accordance with this paragraph are referred to herein as Foam 7E.

The present invention includes XPS foam, including each of Foams 1-6, wherein the foam has a density of 36 kg/m3 or less and aged thermal conductivity of 31 mW/mk or less. For the purposes of convenience, foams in accordance with this paragraph are referred to herein as Foam 8A.

The present invention includes XPS foam, including each of Foams 1-6, wherein the foam has a density of 35 kg/m3 or less and aged thermal conductivity of 31 mW/mk or less. For the purposes of convenience, foams in accordance with this paragraph are referred to herein as Foam 8B.

The present invention includes XPS foam, including each of Foams 1-6, wherein the foam has a density of 34 kg/m3 or less and aged thermal conductivity of 31 mW/mk or less. For the purposes of convenience, foams in accordance with this paragraph are referred to herein as Foam 8C.

The present invention includes XPS foam, including each of Foams 1-6, wherein the foam has a density of 33 kg/m3 or less and aged thermal conductivity of 31 mW/mk or less. For the purposes of convenience, foams in accordance with this paragraph are referred to herein as Foam 8D.

The present invention includes XPS foam, including each of Foams 1-6, wherein the foam has a density of 32 kg/m3 or less and aged thermal conductivity of 31 mW/mk or less. For the purposes of convenience, foams in accordance with this paragraph are referred to herein as Foam 8E.

The present invention includes XPS foam, including each of Foams 1-6, wherein the foam has a density of 36 kg/m3 or less and aged thermal conductivity of 30 mW/mk or less. For the purposes of convenience, foams in accordance with this paragraph are referred to herein as Foam 9A.

The present invention includes XPS foam, including each of Foams 1-6, wherein the foam has a density of 35 kg/m3 or less and aged thermal conductivity of 30 mW/mk or less. For the purposes of convenience, foams in accordance with this paragraph are referred to herein as Foam 9B.

The present invention includes XPS foam, including each of Foams 1-6, wherein the foam has a density of 34 kg/m3 or less and aged thermal conductivity of 30 mW/mk or less. For the purposes of convenience, foams in accordance with this paragraph are referred to herein as Foam 9C.

The present invention includes XPS foam, including each of Foams 1-6, wherein the foam has a density of 33 kg/m3 or less and aged thermal conductivity of 30 mW/mk or less. For the purposes of convenience, foams in accordance with this paragraph are referred to herein as Foam 9D.

The present invention includes XPS foam, including each of Foams 1-6, wherein the foam has a density of 32 kg/m3 or less and aged thermal conductivity of 30 mW/mk or less. For the purposes of convenience, foams in accordance with this paragraph are referred to herein as Foam 9E.

The present invention includes XPS foam, including each of Foams 1-6, wherein the foam has a density of 36 kg/m3 or less and aged thermal conductivity of 29 mW/mk or less. For the purposes of convenience, foams in accordance with this paragraph are referred to herein as Foam 10A.

The present invention includes XPS foam, including each of Foams 1-6, wherein the foam has a density of 35 kg/m3 or less and aged thermal conductivity of 29 mW/mk or less. For the purposes of convenience, foams in accordance with this paragraph are referred to herein as Foam 10B.

The present invention includes XPS foam, including each of Foams 1-6, wherein the foam has a density of 34 kg/m3 or less and aged thermal conductivity of 29 mW/mk or less. For the purposes of convenience, foams in accordance with this paragraph are referred to herein as Foam 10C.

The present invention includes XPS foam, including each of Foams 1-6, wherein the foam has a density of 33 kg/m3 or less and aged thermal conductivity of 29 mW/mk or less. For the purposes of convenience, foams in accordance with this paragraph are referred to herein as Foam 10D.

The present invention includes XPS foam, including each of Foams 1-6, wherein the foam has a density of 32 kg/m3 or less and aged thermal conductivity of 29 mW/mk or less. For the purposes of convenience, foams in accordance with this paragraph are referred to herein as Foam 10E.

The present invention includes XPS foam, including each of Foams 1-10, wherein the foam is a closed cell foam. For the purposes of convenience, foams in accordance with this paragraph are referred to herein as Foam 10F.

The present invention includes XPS foam, including each of Foams 1-10, wherein the foam is a closed cell foam having at least 50% by volume of closed cells. For the purposes of convenience, foams in accordance with this paragraph are referred to herein as Foam 10G.

The present invention includes XPS foam, including each of Foams 1-10, wherein the foam is a closed cell foam having at least 90% by volume of closed cells. For the purposes of convenience, foams in accordance with this paragraph are referred to herein as Foam 10H.

The styrene resin for use in the present invention, including each of Foams 1-10 and each of Methods 1-11, is not particularly limited and examples of the styrene resin include homopolymers of styrene monomers such as styrene, methylstyrene, ethylstyrene, isopropylstyrene, dimethylstyrene, bromostyrene, chlorostyrene, vinyltoluene, and vinylxylene, or copolymers of two or more of the monomers, copolymers obtained by copolymerization of the styrene monomer with at least one or two or more of monomers such as divinylbenzene, butadiene, acrylic acid, methacrylic acid, methyl acrylate, methyl methacrylate, acrylonitrile, maleic anhydride, and itaconic anhydride, and the like. The monomers to be copolymerized with the styrene monomer, such as acrylic acid, methacrylic acid, methyl acrylate, methyl methacrylate, maleic anhydride, and itaconic anhydride, can be used with such an amount that the physical properties, such as compressive strength, of the extruded polystyrene foam to be produced are not impaired. The styrene resin for use in the present invention is not limited to the homopolymers or the copolymers of the styrene monomers and may be a blend of the homopolymers or the copolymers of the styrene monomers and the homopolymers or the copolymers of the other monomers, and a diene rubber reinforced polystyrene or an acrylic rubber reinforced polystyrene can be blended.

The styrene resin for use in the present invention, including each of Foams 1-10 and each of Methods 1-11, is not particularly limited and examples of the styrene resin include homopolymers of styrene monomers such as styrene, methylstyrene, ethylstyrene, isopropylstyrene, dimethylstyrene, bromostyrene, chlorostyrene, vinyltoluene, and vinylxylene, or copolymers of two or more of the monomers, copolymers obtained by copolymerization of the styrene monomer with at least one or two or more of monomers such as divinylbenzene, butadiene, acrylic acid, methacrylic acid, methyl acrylate, methyl methacrylate, acrylonitrile, maleic anhydride, and itaconic anhydride, and the like. The monomers to be copolymerized with the styrene monomer, such as acrylic acid, methacrylic acid, methyl acrylate, methyl methacrylate, maleic anhydride, and itaconic anhydride, can be used with such an amount that the physical properties, such as compressive strength, of the extruded polystyrene foam to be produced are not impaired. The styrene resin for use in the present invention is not limited to the homopolymers or the copolymers of the styrene monomers and may be a blend of the homopolymers or the copolymers of the styrene monomers and the homopolymers or the copolymers of the other monomers, and a diene rubber reinforced polystyrene or an acrylic rubber reinforced polystyrene can be blended. The styrene resin for use in the present invention may be a styrene resin having a branched structure for the purpose of adjusting the melt volume rate (hereinafter also referred to as MVR), a melt viscosity and a melt tension in molding, and the like.

According to preferred embodiments, the foams of the present invention, including each of Foams 1-10, are formed from a general purpose styrene resin, preferably having an MVR of 0.1 to 50 g/10 minutes. Such resins are preferably used in the respect that a thermoplastic resin foam in which the moldability in extrusion foam molding is excellent, the discharge amount in molding, the thickness and the width and the apparent density or the closed cell ratio of the obtained extruded polystyrene foam can be adjusted to desired values. The MVR of the styrene resin can include from 0.3 to 30 g/10 minutes, or 0.5 to 25 g/10. In the present invention, the MVR is measured by ISO 1133.

In the present invention, among the styrene resin mentioned above, polystyrene resin is suitable in the respect of economical efficiency and processability. When higher heat resistance is required in an extruded foam, it is preferable to use a styrene-acrylonitrile copolymer, (meth)acrylic acid-copolymerized polystyrene, maleic anhydride-modified polystyrene. When a higher impact resistance is demanded in an extruded foam, it is preferable to use rubber-reinforced polystyrene. The styrene resin may be used alone or two or more kinds of styrene resin different in a copolymerization component, a molecular weight and a molecular weight distribution, a branched structure, an MVR, and the like may be used as a mixture.

The PS used to form the present foams, including each of Foams 1-10, and which is used in accordance with the present methods, including each of Methods 1-11, can have properties within each of the broad, intermediate and narrow ranges identified in the following table:

| | Broad | Intermediate | Narrow |
|---|---|---|---|
| | Range | Range | Range |
| Polymer | | | |
| property, | | | |
| Melt Volume | 0.1-50 | 10-40 | 15-30 |
| Rate, ISO 1133 | | | |
| (cm3/10 min.) | | | |
| Vicat Softening | 90-115 | 95-110 | 95-105 |
| Temperature | | | |
| VST/B/50 | | | |
| (50N, 50° C./h) | | | |
| Melting | 100-350 | 150-300 | 180-280 |
| Temperature, | | | |
| Tm, ° C. | | | |

### Methods

Applicants have found that unexpected advantages can be achieved with respect to the preparation of thermoplastic foams, including each of Foam 1-Foam 10E, by using a blowing agent of the present invention in the foam forming process.

In particular aspects, the present invention includes method for making thermoplastic XPS foam comprising:

(i) providing PS; and

(ii) foaming the PS using any one of the blowing agents of the present invention, including each of Blowing Agent 1 through Blowing Agent 6. For the purposes of convenience, methods in accordance with this paragraph are referred to herein as Method 1.

The present invention also provides methods for forming extruded thermoplastic foam comprising:

(i) providing a thermoplastic material;

(ii) extruding the thermoplastic material; and

(iii) foaming the thermoplastic material using any one of the blowing agents of the present invention, including each of Blowing Agent 1 through Blowing Agent 6. For the purposes of convenience, methods in accordance with this paragraph are referred to herein as Method 2.

The present invention also provides methods for forming XPS comprising:

(i) providing a thermoplastic polystyrene;

(ii) extruding the thermoplastic polystyrene; and

(iii) foaming a polystyrene foam using any one of the blowing agents of the present invention, including each of Blowing Agent 1 through Blowing Agent 6. For the purposes of convenience, methods in accordance with this paragraph are referred to herein as Method 3.

The present invention also provides methods for making XPS foams comprising:

(i) providing PS; and

(ii) foaming the PS using any one of the blowing agents of the present invention, including each of Blowing Agent 1 through Blowing Agent 6, wherein the foam has a density of about 36 kg/m3 or less and an aged thermal conductivity of 32 mW/mk or less. For the purposes of convenience, methods in accordance with this paragraph are referred to herein as Method 4A.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 35 kg/m3 or less and an aged thermal conductivity of 32 mW/mk or less. For the purposes of convenience, methods in accordance with this paragraph are referred to herein as Method 4B.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 34 kg/m3 or less and an aged thermal conductivity of 32 mW/mk or less. For the purposes of convenience, methods in accordance with this paragraph are referred to herein as Method 4C.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 33 kg/m3 or less and an aged thermal conductivity of 32 mW/mk or less. For the purposes of convenience, methods in accordance with this paragraph are referred to herein as Method 4D.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 32 kg/m3 or less and an aged thermal conductivity of 32 mW/mk or less. For the purposes of convenience, methods in accordance with this paragraph are referred to herein as Method 4E.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 31 kg/m3 or less and an aged thermal conductivity of 32 mW/mk or less. For the purposes of convenience, methods in accordance with this paragraph are referred to herein as Method 4F.

The present invention also provides methods for making XPS foams comprising:

(i) providing PS; and

(ii) foaming the PS using any one of the blowing agents of the present invention, including each of Blowing Agent 1 through Blowing Agent 6, wherein the foam has a density of about 36 kg/m3 or less and an aged thermal conductivity of 31 mW/mk or less. For the purposes of convenience, methods in accordance with this paragraph are referred to herein as Method 5A.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 35 kg/m3 or less and an aged thermal conductivity of 31 mW/mk or less. For the purposes of convenience, methods in accordance with this paragraph are referred to herein as Method 5B.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 34 kg/m3 or less and an aged thermal conductivity of 31 mW/mk or less. For the purposes of convenience, methods in accordance with this paragraph are referred to herein as Method 5C.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of less about 33 kg/m3 and an aged thermal conductivity of 31 mW/mk or less. For the purposes of convenience, methods in accordance with this paragraph are referred to herein as Method 5D.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 32 kg/m3 or less and an aged thermal conductivity of 31 mW/mk or less. For the purposes of convenience, methods in accordance with this paragraph are referred to herein as Method 5E.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 31 kg/m3 or less and an aged thermal conductivity of 31 mW/mk or less. For the purposes of convenience, methods in accordance with this paragraph are referred to herein as Method 5F.

The present invention also provides methods for making XPS foams comprising:

(i) providing PS; and

(ii) foaming the PS using any one of the blowing agents of the present invention, including each of Blowing Agent 1 through Blowing Agent 6, wherein the foam has a density of about 36 kg/m3 or less and an aged thermal conductivity of 30 mW/mk or less. For the purposes of convenience, methods in accordance with this paragraph are referred to herein as Method 6A.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 35 kg/m3 or less and an aged thermal conductivity of 30 mW/mk or less. For the purposes of convenience, methods in accordance with this paragraph are referred to herein as Method 6B.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 34 kg/m3 or less and an aged thermal conductivity of 30 mW/mk or less. For the purposes of convenience, methods in accordance with this paragraph are referred to herein as Method 6C.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of less about 33 kg/m3 and an aged thermal conductivity of 30 mW/mk or less. For the purposes of convenience, methods in accordance with this paragraph are referred to herein as Method 6D.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 32 kg/m3 or less and an aged thermal conductivity of 30 mW/mk or less. For the purposes of convenience, methods in accordance with this paragraph are referred to herein as Method 6E.

The present invention also provides methods for forming extruded thermoplastic foam comprising:

(i) providing PS;

(ii) extruding PS; and

(iii) foaming the PS using any one of the blowing agents of the present invention, including each of Blowing Agent 1 through Blowing Agent 6, wherein the foam has a density of about 31 kg/m3 or less and an aged thermal conductivity of 30 mW/mk or less. For the purposes of convenience, methods in accordance with this paragraph are referred to herein as Method 6F.

The present invention also provides methods for making thermoplastic foams, including each of Method 1 through Method 6 wherein said blowing agent is used in an amount of from about 4 parts per hundred of thermoplastic resin material (hereinafter “pph” or “pphr”) to about 10 pphr. For the purposes of convenience, methods in accordance with this paragraph are referred to herein as Method 7.

The present invention also provides methods for making thermoplastic foams, including each of Method 1 through Method 6, wherein said blowing agent is used in an amount of from about 5 pphr to about 9 pphr. For the purposes of convenience, methods in accordance with this paragraph are referred to herein as Method 8A.

The present invention also provides methods for making thermoplastic foams, including each of Method 1 through Method 6, wherein said blowing agent is used in an amount of from 5 pphr to 9 pphr. For the purposes of convenience, methods in accordance with this paragraph are referred to herein as Method 8A.

The present invention also provides methods for making thermoplastic foams, including each of Method 1 through Method 6, wherein said blowing agent is used in an amount of from about 6 pphr to about 8 pphr. For the purposes of convenience, methods in accordance with this paragraph are referred to herein as Method 9A.

The present invention also provides methods for making thermoplastic foams, including each of Method 1 through Method 6, wherein said blowing agent is used in an amount of from 6 pphr to 8 pphr. For the purposes of convenience, methods in accordance with this paragraph are referred to herein as Method 9B.

The present invention also provides methods for making thermoplastic foams, including each of Method 1 through Method 6, wherein said blowing agent is used in an amount of from about 6.5 pph. For the purposes of convenience, methods in accordance with this paragraph are referred to herein as Method 10A.

The present invention also provides methods for making thermoplastic foams, including each of Method 1 through Method 6, wherein said blowing agent is used in an amount of from about 7 pph. For the purposes of convenience, methods in accordance with this paragraph are referred to herein as Method 10B.

The present invention also provides methods for making thermoplastic foams, including each of Method 1 through Method 10, wherein said step of providing said thermoplastic material or PS comprises including in said thermoplastic material one or more optional components selected from surfactants, polymer modifiers, toughening agents, colorants, dyes, solubility enhancers, rheology modifiers, plasticizing agents, flammability suppressants, antimicrobial agents, viscosity reduction modifiers, fillers, vapor pressure modifiers, nucleating agents, catalysts and the like. For the purposes of convenience, methods in accordance with this paragraph are referred to herein as Method 11.

The methods of the present invention, including each of Methods 1-10, can be formed from any PS resin, including general purpose styrene resin, preferably having an MVR of 0.1 to 50 g/10 minutes, more preferably of from 10 to 40 g/10 minutes, more preferably from 10 to 30 g/10 minutes.

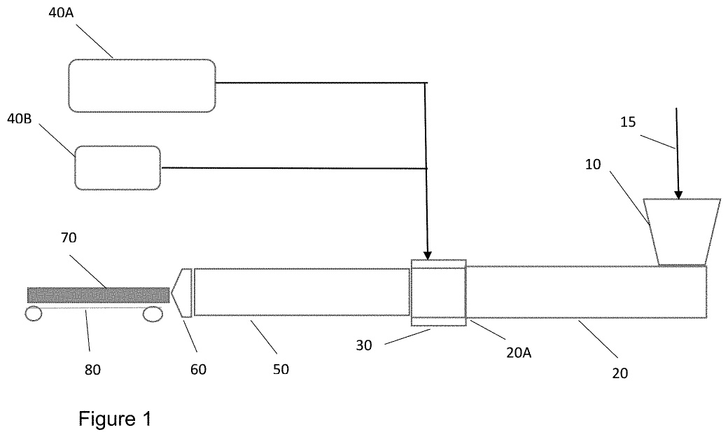

The methods can be carried out, by way of example, using extrusion equipment of the general type disclosed in FIG. 1, which is described below in more detail below in connection with the examples. It will be appreciated that while FIG. 1 shows only a single feed point for introducing blowing agent into the extrusion process, the use of multiple feed points to introduce the blowing agent may be used. Furthermore, it will be appreciated that the term “blowing agent” as used herein, including each of Blowing Agents 1-4, includes not only the defined set of components introduced into the extruder when there is a single introduction point, but also the aggregate combination of components that may be introduced at plural points into the extrusion or other foaming equipment.

### EXAMPLES

The following examples are provided for the purpose of illustrating the present invention but without limiting the scope thereof.

The examples utilized an extrusion apparatus substantially as illustrated in FIG. 1. In particular, the apparatus included a raw material feed hopper 10 for holding polystyrene feed material 15, together with any optional components (which may be added with the polystyrene or optionally elsewhere in the process depending on the particular needs of the user). In the case of the examples hereof, the polystyrene feed is in the form of general purpose polystyrene pellets sold by Ineos under the trade designation Styrolution 156F and having the following properties:

| Property, | | | |
|---|---|---|---|
| Test | | | |
| Condition | Standard | Unit | Values |
| Melt Volume Rate, | ISO 1133 | cm³/10 min | 28 |
| 200° C./5 kg | | | |
| Vicat Softening | ISO 306 | ° C. | 101 |
| Temperature | | | |
| VST/B/50 | | | |
| (50N, 50° C./h) | | | |
| Melt Temperature | ISO 294 | ° C. | 180-280 |
| Range | | | |

The feed material also included the flame retardant sold under the trade designation Apryos 5PB12HT, the nucleating agent (GRANIC 2281) and processing aid (Zinc Stearate). The total of the raw material feed stream 15 used to form the foam and introduced into the single screw extruder 20 are based on the following concentrations of components:

| Component | pph |
|---|---|
| polystyrene (Styrolution 156F) | 100 |
| Copolymer (Low density | 0.3 |
| polyethylene-PE 003 | |
| from Repsol) | |
| flame retardants | 2 |
| (Apyros 5PB12HT) | |
| nucleating agent (GRANIC 2281) | 0.8 |
| processing aid (Zinc Stearate) | 0.8 |
| Blowing agent (total of all | 5.2-9 |
| co-blowing agents) | |

The feed materials 15, excluding the blowing agent, were charged to the hopper and delivered to the screw extruder 10 at a nominal rate of about 3.3 kilograms per hour and the screw operated with at a nominal 85 rpm. The extruder 20 had thermocouples (not shown) located at three points along the length thereof and a pressure sensor (not shown) at the discharge end 20A of the extruder. A mixer section 30 was located at the discharge end 20A of the extruder for receiving blowing agent components via one or more metering pumps 40A and 40B and mixing those blowing agents into the polystyrene melt in the mixer section. Sensors (not shown) were included for monitoring the temperature and pressure of the mixer section 30. The mixer section 30 discharged the melt with the blowing agent into a pair of melt coolers 50 oriented in series, with temperature sensors (not shown) located in each cooler to monitor the melt temperature. The melt was then extruded through a die 60 which also had temperature and pressure sensors (not shown) for monitoring the pressure and temperature at the die. The die pressure was varied from 70 to 100 bars to minimize the density for each blowing agent tested and the die temperature was kept at 128° C. Exiting the die was a foamed sheet of polystyrene 70 which is carried away from the extrusion equipment by a conveyor belt 80.

The equipment illustrated in FIG. 1 and described above was used for each of the experimental tests described in the examples below to form a foam. After the foam is formed, the density and aged thermal conductivity (also referred to as “aged lambda”) were measured. The aged lambda values were measured according to ISO 11561:199 (providing similar results as European Standard BS EN 13164:2012+A1:2015), modified in accordance with the description proved below:

Day 0—the foam is extruded

Day 1—initial thermal conductivity of the block (skins, 120×120 mm, thickness of 15-20 mm) is determined at 10° C.+/−2° C.

Day 4—slicing of the block into 6 mm thick slices is performed (with skins removed) to obtain one slice per extruded sample that is 23 mm wide and 120 mm long and then at least 4 slices are stacked; thermal conductivity of the stack is measured at 10° C.+/−2° C. and then the slices are separated and kept at about 23° C. and 50% relative humidity.

Days 6-36—the procedure of Day 4 is repeated every two or three days until about 28 days is reached to obtain aged thermal conductivity by Method A, which comprises plotting the lambda values against time and then calculating aged thermal conductivity (Raged).

### Comparative Example 1—XPS Foam from Blowing Agent Consisting of 1234ze(E) and Methyl Formate

An extruded polystyrene foam was produced using the equipment and materials described above and illustrated in FIG. 1. About 6.5 pphr of the blowing agent (designated BA-C1A in the table below) produced a foam having the density and aged lambda reported in Table C1A below.

TABLE C1A

| | BA-C1A | | FOAM | |
|---|---|---|---|---|
| | | Wt % of | PROPERTIES | |
| | | total | | Aged |
| | | blowing | Density | Lambda |
| Component | PPHR | agent | (kg/m³) | (mW/mk) |
| 1234ze(E) | 4 | 62 | 43.5 | 29.5 |
| Methyl | 2.5 | 38 | | |
| formate | | | | |

As can be seen from the results above, this combination of components produced a foam with a desirable aged lambda of less than 30 but with an undesirable density of much greater than the desired density of 32 or below. In an attempt to modify the blowing agent to produce a foam with a reduced density, a second foam extrusion was performed using the same equipment, the same operating criteria, and the same raw materials as described above in connection with Comparative Example CIA, except that 0.75 pphr of CO2 was added to the blowing agent combination. The blend components (identified in the table below as BA-C1B) and the foam results are reported in Table C1B below:

TABLE C1B

| | BA-C1B | | Foam | |
|---|---|---|---|---|
| | | Wt % | Properties | |
| | PPH | of | | Aged |
| | by | BA- | Density | Lambda |
| Component | wt. | C1B | (kg/m³) | (mW/mk) |
| 1234ze(E) | 4 | 55 | 41 | 30.5 |
| Methyl | 2.5 | 35 | | |
| formate | | | | |
| CO2 | 0.75 | 10 | | |

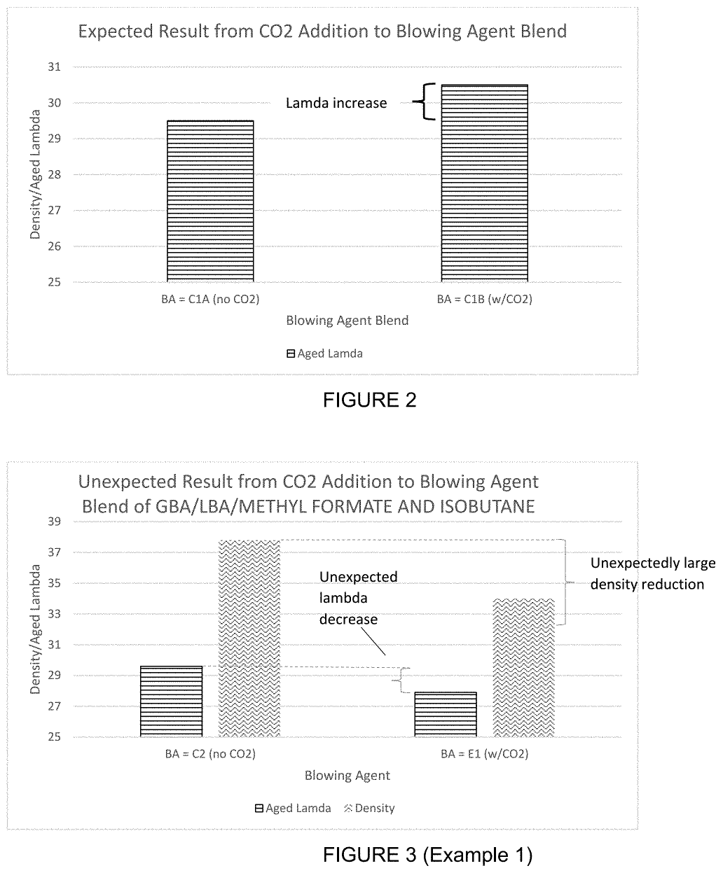

As can be seen from the comparative example above, the addition of CO2 to the blowing agent blend had the expected result of decreasing the density of the foam. In particular, the foam density decreased from 43.5 to 41, which is a decrease of about 6 relative percent. However, this reduction was not nearly enough of a decrease to result in a density of about 32 or below. The addition of CO2 also had the expected disadvantage of increasing the thermal conductivity of the foam. In the particular case of this example, the aged lambda increased by about 3%, which is an undesirable result. In the particular case of this example, the aged lambda has increased by almost 5%, which is a highly undesirable result. This expected detrimental effect is illustrated in FIG. 2. Furthermore the aged lambda is not below 30, as is most desired.

### Comparative Example 2—XPS Foam from Blowing Agent Consisting of 1233zd(E), 1234ze(E), Isobutane and Methyl Formate

An extruded polystyrene foam was produced using the equipment and materials described above and illustrated in FIG. 1. About 7.25 pphr of the blowing agent (designated BA-C2 in the table below) produced a foam having the density and aged lambda reported in Table C2 below.

TABLE C2

| | BA-C2 | | | |
|---|---|---|---|---|
| | | Wt % | | |
| | | of | FOAM | |
| | | total | PROPERTIES | |
| | | | | Aged |
| | | blowing | Density | Lambda |
| Component | PPHR | agent | (kg/m3) | (mW/mk) |
| 1234ze(E) | 3 | 41.4 | 37.8 | 29.6 |
| 1233zd(E) | 1 | 13.8 | | |
| Methyl | 0.75 | 10.3 | | |
| formate | | | | |
| isobutane | 2.5 | 34.5 | | |

As can be seen from the results above, this combination of components produced a foam with a desirable aged lambda of less than 30 but with an undesirable density of much greater than the desired density of about 32 or below, although the density was much substantially lower than the density achieved with BA-C1A in Comparative Example 1.

### Example 1—XPS Foam from Blowing Agent Consisting of 1233zd(E), 1234ze(E), Isobutane, Methyl Formate and CO2

In an attempt to modify the blowing agent used in Comparative Example C2 to achieve a foam with a reduced density, a second foam extrusion was performed using the same equipment, the same operating criteria, and the same raw materials as described above in connection with Comparative Example C2, except that 0.75 pphr of CO2 was added to the blowing agent combination. The blend components and the foam results are reported in Table E1 below:

TABLE E1

| | Blowing | | | |
|---|---|---|---|---|
| | Agent E1 | | | |
| | | Wt % | | |
| | | of | Foam | |
| | | total | Properties | |
| | | blowing | | Aged |
| | PPH | agent | Density | Lambda |
| Component | by wt. | E1 | (kg/m3) | (mW/mk) |
| 1233zd(E) | 3 | 13.3 | 34 | 27.9 |
| 1234ze(E) | 1 | 40 | | |
| Methyl | 0.75 | 10 | | |
| formate | | | | |
| Isobutane | 2.5 | 33.3 | | |
| CO2 | 0.25 | 3.3 | | |

As can be seen from the results reported above, the addition of CO2 to the blowing agent blend had the unexpected result of decreasing the density of the foam by about 11% (from 37.8 to 34), which is about two (2) times the reduction achieved by using the same amount of CO2 in connection with the blowing agent blend in Comparative Example C1 (43.5 to 41, for a reduction of 6.1%). This unexpected result is very important because it is very desirable for a variety of commercial applications for the foam to have a density of about 34 or less. Moreover, the addition of CO2 also had the unexpected advantage of significantly decreasing the thermal conductivity of the foam. This combined with the unexpectedly low aged lambda achieved without the CO2, produces a highly desirable and unexpected result, and this is illustrated in FIG. 3.

### Comparative Example C3—XPS Foam from Blowing Agent Consisting of Trans-HFO-1234ze, Isobutane and Methyl Formate

An extruded polystyrene foam was produced using the equipment and materials described above and illustrated in FIG. 1. About 6.5 pphr of the blowing agent (designated BA-C3 in the table below) produced a foam having the indicated density and aged lambda.

TABLE C3

| | | Foam | |
|---|---|---|---|
| | | Properties | |
| | | | Aged |
| | BA-C3, | Density | Lambda |
| Component | Wt % | (kg/m3) | (mW/mk) |
| 1234ze(E) | 65 | 38 | 31.3 |
| Isobutane | 24.4 | | |
| Methyl formate | 10.6 | | |

As can be seen from the comparative example above, the combination of 1234ze(E), isobutane and methyl formate in the indicated relative amounts was able to achieve a relatively low aged lambda value, although still not below 31. With respect to density, the foam had an undesirably high density of 38.

### Comparative Example C4—XPS Foam from Blowing Agent Consisting of Trans-HFO-1234ze, Isobutane and Acetone

Foam extrusion runs were performed using the same equipment, the same operating criteria, and the same raw materials as described above in connection with Comparative Example 3, except using 7 pph of a blowing agent consisting of the components indicated in Table C4 below to produce a foam having the indicated density and aged lambda.

TABLE C4

| | Wt % | Foam | |
|---|---|---|---|
| | of | Properties | |
| | total | | Aged |
| | blowing | Density | Lambda |
| Component | agent | (kg/m3) | (mW/mk) |
| 1234ze(E) | 57.1 | 36.3 | 33.2 |
| Isobutane | 21.4 | | |
| acetone | 21.4 | | |

As can be seen from the comparative example above, the combination of 1234ze(E), isobutane and acetone in the indicated relative amounts produced a foam with an even higher aged lambda value than Comparative Example C3, although with a slightly reduced density of 36.3. Thus, the use of this blowing agent was not able to provide a polystyrene foam with a density less than 35 kg/m3 that at the same time had a thermal conductivity below 31 mW/mk.

### Example 2—XPS Foam from Blowing Agent Consisting of Trans-HFO-1234ze, Isobutane, Methyl Formate and CO2

Foam extrusion runs were performed using the same equipment, the same operating criteria, and the same raw materials as described above in connection with Comparative Examples C3 and C4, except using 7 pph of a blowing agent consisting of the components indicated in Table E2 below to produce a foam having the indicated density and aged lambda:

TABLE E2

| | Wt % | Foam | |
|---|---|---|---|
| | of | Properties | |
| | total | | Aged |
| | blowing | Density | Lambda |
| Component | agent | (kg/m3) | (mW/mk) |
| 1234ze(E) | 61.54 | 36.5 | 29.5 |
| Isobutane | 23.1 | | |
| Methyl formate | 11.5 | | |
| CO2 | 3.9 | | |

As can be seen from the example above, a surprising and highly beneficial result is achieved using the blowing agent within the scope of the present invention. In particular, as noted above in connection with Comparative Examples C2 and C3, neither the combination of 1234ze(E), isobutane and methyl formate nor the combination of 1234ze(E), isobutane and acetone was able to achieve an aged lambda value below 31 or a foam density of about 36. It would be expected that the addition of CO2 as a co-blowing agent blend of Comparative Example C2 would cause an increase in the aged lambda of the foam, but applicants have surprisingly found that the use of relatively small amounts of CO2 in combination with 1234ze(E), isobutane and methyl formate was able to produce a not only an expected reduction in foam density, but unexpectedly a substantial reduction in aged lambda, from a value of value of less than 31.3 to a value less than 30, which was not achieved by any of the Comparative Examples.

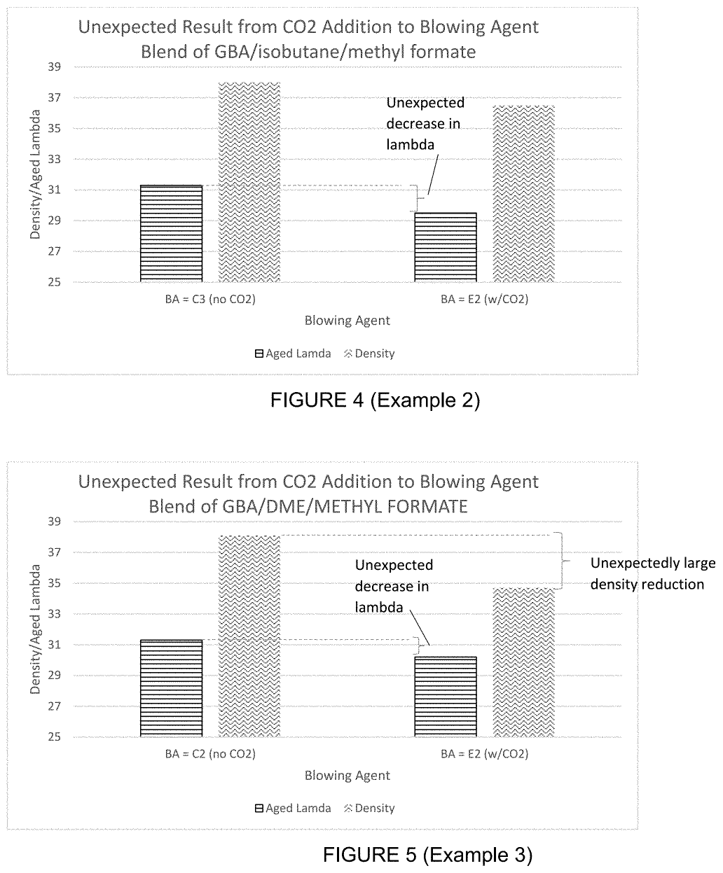

Unexpectedly, however, a blowing agent comprising 1234ze(E), isobutane, methyl formate and CO2 according to the present invention surprisingly was able to produce a foam density below 36.6 and an aged lambda value of less than 30, which was not achieved by any of Comparative Examples. This result is surprising and highly beneficial, and the results are is illustrated in FIG. 4.

### Comparative Example C5—XPS Foam Made with 1234ze(E) and Dimethylether (DME) and Methyl Formate

An extruded polystyrene foam was produced using the equipment and materials described above and illustrated in FIG. 1. The blowing agent (designated BA-05 in the table below) was a combination of components consisting of 1234ze(E), DME and methyl formate. The blowing agent was added to the melt in an amount of 6.25 pphr (as used herein, “pphr” means parts per hundred of polymer resin on a weight basis). The die pressure which minimized the foam density was determined and used to produce the foam. The results are reported in C5 below.

TABLE C5

| | | Foam Properties | |
|---|---|---|---|
| | | | Aged |
| | BA-C5, | Density | Lambda |
| Component | Wt % | (kg/m3) | (mW/mk) |
| 1234ze(E) | 64 | 38.1 | 31.3 |
| DME | 24 | | |
| Methyl | 12 | | |
| formate | | | |

As can be seen from the comparative example above, the combination of 1234ze(E), DME and methyl formate in the indicated amounts produced a foam with an undesirably high density of 38.1 and with a relatively low aged lambda value, although still not below the most preferred value of 31 or below.

### Example 3—XPS Foam from Blowing Agent Consisting of Trans-HFO-1234ze, DME, Methyl Formate and CO2

Foam extrusion runs were performed using the same equipment, the same operating criteria, and the same raw materials as described above in connection with Comparative Example C5, except that 0.25 of CO2 was added to the blowing agent (for a total blowing agent amount of 6.5 pphr). The blowing agent (designated BA-E3 in the table below) produced a foam having the indicated density and aged lambda:

TABLE E3

| | | Foam | |
|---|---|---|---|
| | | Properties | |
| | | | Aged |
| | BA-E3, | Density | Lambda |
| Component | Wt % | (kg/m3) | (mW/mk) |
| 1234ze(E) | 61.54 | 34.7 | 30.2 |
| Dimethyl ether | 23.08 | | |
| Methyl formate | 11.54 | | |
| CO2 | 3.9 | | |

As can be seen from the example above, a surprising and highly beneficial result is achieved using the blowing agent within the scope of the present invention. In particular, as noted above in connection with Comparative Example 5, the combination of 1234ze(E), DME and methyl formate was not able to achieve an aged lambda value below 31 or a foam density below 38.1. It would be expected that the addition of CO2 as a co-blowing agent would cause an increase in the aged lambda of the foam, but applicants have surprisingly found that the use of relatively small amounts of CO2 in combination with 1234ze(E), DME and methyl formate was able to produce a foam density below 35 and an aged lambda value of less than 31, which was not achieved by any of Comparative Examples, and this is illustrated in FIG. 5.

### Comparative Example C6—XPS Foam from Blowing Agent Consisting of Trans-HFCO-1233zd, Isobutane and Methyl Formate

Foam extrusion runs were performed using the same equipment, the same operating criteria, and the same raw materials as described above in connection with comparative examples C1-C5, except using 6.5 pph of a blowing agent consisting of the components indicated in Table C6 below to produce a foam having the indicated density and aged lambda.

TABLE C6

| | Wt % | Foam | |
|---|---|---|---|
| | of | Properties | |
| | total | | Aged |
| | blowing | Density | Lambda |
| Component | agent | (kg/m3) | (mW/mk) |
| 1233zd(E) | 61.5 | 34.8 | 31.5 |
| Isobutane | 23.1 | | |
| Methyl formate | 15.4 | | |

As can be seen from the comparative example above, while the combination of 1233zd(E), isobutane and methyl formate in the indicated relative amounts was able to achieve a relatively low aged lambda value, although still not below 31, it produced a foam with a density of almost 35, with is undesirably high.

### Example 4—XPS Foam from Blowing Agent Consisting of Trans-HFCO-1233zd, Isobutane, Methyl Formate and CO2

Foam extrusion runs were performed using the same equipment, the same operating criteria, and the same raw materials as described above in connection with Comparative Example C6, except using 6.5 pph of a blowing agent consisting of the components indicated in Table E4 below to produce a foam having the indicated density and aged lambda:

TABLE E4

| | Wt % | Foam | |
|---|---|---|---|
| | of | Properties | |
| | total | | Aged |
| | blowing | Density | Lambda |
| Component | agent | (kg/m3) | (mW/mk) |
| 1233zd(E) | 61.54 | 32.3 | 31.6 |
| Isobutane | 23.1 | | |
| Methyl formate | 11.5 | | |
| CO2 | 3.9 | | |

As can be seen from the example above, a surprising and highly beneficial result is achieved using the blowing agent within the scope of the present invention. In particular, as noted above in connection with Comparative Example C6, the combination of 1233zd(E), isobutane and methyl formate was not able to achieve a foam density below 34. It would be expected that the addition of CO2 as a co-blowing agent blend of Comparative Example C6 would cause a substantial increase in the aged lambda of the foam, but applicants have surprisingly found that the use of relatively small amounts of CO2 in combination with 1233zd(E), isobutane and methyl formate was able to produce not only an expected reduction in foam density to a value close to 32, but unexpectedly this reduction in density was achieved without a substantial reduction in aged lambda. This result is surprising and highly beneficial.

### Comparative Example 7—XPS Foam from Blowing Agent Containing 1234ze(E), 1233zd(E) and Isobutane

Foam extrusion runs were performed using the same equipment, the same operating criteria, and the same raw materials as described above in connection with comparative examples C1-C6, except using 7.5 pph of a blowing agent consisting of the components indicated in Tables C6 below to produce a foam having the indicated density and aged lambda:

TABLE 7

| | | Wt % | Foam | |
|---|---|---|---|---|
| | | of | Properties | |
| Blowing | | total | | Aged |
| Agent | PPH | blowing | Density | Lambda |
| Component | RESIN | agent | (kg/m3) | (mW/mk) |
| 1234ze(E) | 3 | 46.2 | 35.3 | 28.7 |
| 1233zd(E) | 1 | 15.4 | | |
| isobutane | 2.5 | 38.5 | | |

As can be seen from the comparative example above, this combination of components in the indicated relative amounts produced a foam with an undesirably high density of greater than 35, although the density produced had a desirable value of 28.7.

### Comparative Example 8—XPS Foam from Blowing Agent Consisting of 1234ze(E), 1233zd(E), Isobutane, and Ethanol

Foam extrusion runs were performed using the same equipment, the same operating criteria, and the same raw materials as described above in connection with the runs reported in Table C7 of Comparative Example 7, except that 0.5 and 0.75 pph of ethanol were added as a co-blowing agent (to produce blowing agents designated BA-C8A and BA-C8B) as indicated in Table C8 below to produce foams (indicated as C8Foam1 and C8Foam2) having the indicated density and aged lambda:

TABLE C8

| | | Wt % of | | |
|---|---|---|---|---|
| | | total | Foam Properties | |
| | PPH | blowing | C8Foam1/C8Foam2 | |
| Blowing | RESIN | agent | | Aged |
| Agent | BA-C8A/ | BA-C8A/ | Density | Lambda |
| Component | BA-C8B | BA-C8B | (kg/m3) | (mW/mk) |
| 1234ze(E) | 3/3 | 41.4/40.0 | 35.4/34.6 | 28.9/29.1 |
| 1233zd(E) | 1/1 | 13.8/13.3 | | |
| Ethanol | 0.5/0.75 | 6.9/10.0 | | |
| isobutane | 2.5/2.5 | 34.5/33.3 | | |

As can be seen from the comparative example above, the addition of ethanol as a co-blowing agent in the indicated relative amounts produced a foam without substantially reducing the density to a value below much below the highly undesirably density of about 35. Applicants, noted, however, that the addition of ethanol to these blends had the desirable result of substantially decreasing the aged thermal conductivity of the foams.

### Examples 5A and 5B—XPS Foam from Blowing Agent Consisting of Trans-HFO=1234ze, Trans-HFCO-1233zd, Isobutane, Ethanol and CO2

Foam extrusion runs were performed using the same equipment, the same operating criteria, and the same raw materials as described above in connection with Comparative Example 8 except CO2 was added as a co-blowing agent in two different concentration (identified as BA-E5A and BA-E5B) as reported in Table E5 below to produce two foams (identified as Foam E5A and Foam E5B) having the indicated density and aged lambda:

TABLE E5

| | | Wt % of | | |
|---|---|---|---|---|
| | | total | Foam Properties | |
| | PPH | blowing | FoamE5A/FoamE5B | |
| Blowing | RESIN | agent | | Aged |
| Agent | BA-E5A/ | BA-E5A/ | Density | Lambda |
| Component | BA-E5B | BA-E5B | (kg/m3) | (mW/mk) |
| 1234ze(E) | 3/3 | 41.4/40.0 | 32.3/31.4 | 27.9/28.8 |
| 1233zd(E) | 1/1 | 13.8/13.3 | | |
| Ethanol | 0.5/0.75 | 6.9/10.0 | | |
| isobutane | 2.5/2.5 | 34.5/33.3 | | |
| CO2 | 0.25/0.25 | 3.4/3.3 | | |

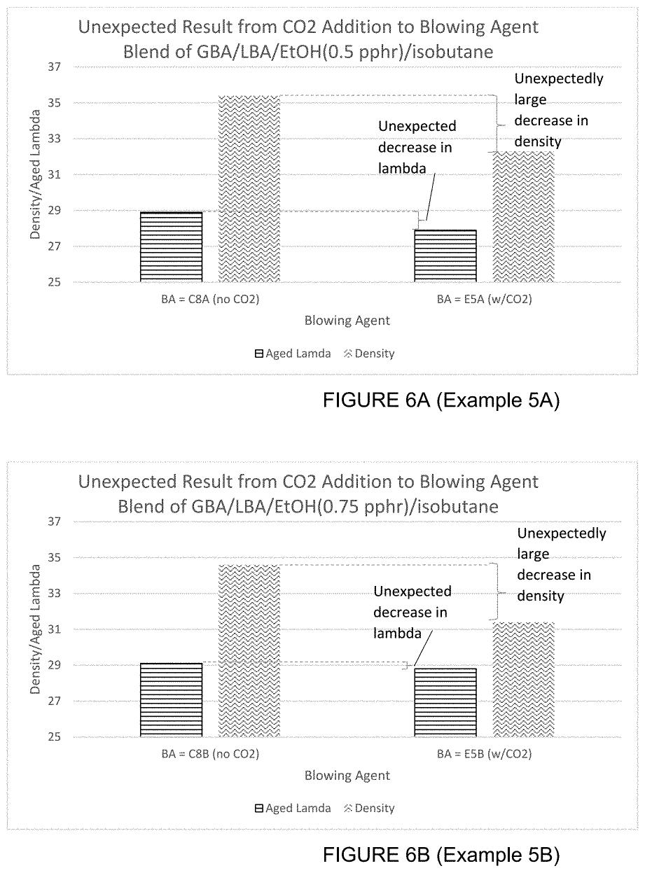

As can be seen from the example above, a surprising and highly beneficial result is achieved using the blowing agent within the scope of the present invention. In particular, as noted above in connection with Comparative Example C8, the combination of 1234ZE(e), 1233zd(E), ethanol and isobutane was not able to achieve a foam density below 34. It would be expected that the addition of CO2 as a co-blowing agent blend of Comparative Example C8 would cause a substantial increase in the aged lambda of the foam, but applicants have surprisingly found that the use of relatively small amounts of CO2 in combination with 1234ZE(e), 1233zd(E), ethanol and isobutane was able to produce not only an expected reduction in foam density to a value close to or below 32, but unexpectedly this reduction in density was achieved without a substantial reduction in aged lambda. This result is surprising and highly beneficial, as illustrated in FIGS. 6A and 6B.

What is claimed is:

1. A blowing agent for producing extruded polystyrene foam having low aged lambda and low foam density, said blowing agent comprising:
(a) from about 50% by weight to about 70% by weight of one or more HFOs having three carbon atoms and/or one or more HFCOs having three carbon atoms;
(b) a first co-blowing agent consisting essentially of from about 5% to about 20% by weight of methyl formate, ethanol and combinations of these;
(c) a second co-blowing agent consisting essentially of from about 20% to about 40% by weight of dimethyl ether, isobutane and combinations of these; and
(d) a third co-blowing agent consisting essentially of from about 2% to about 5% by weight of carbon dioxide.

2. The blowing agent of claim 1 wherein said one or more HFOs having three carbon atoms and/or one or more HFCOs having three carbon atoms are selected from 1234ze(e), 1233zd(Z) and combinations of these.

3. The blowing agent of claim 2 wherein first co-blowing agent comprises methyl formate.

4. The blowing agent of claim 2 wherein first co-blowing agent comprises ethanol.

5. The blowing agent of claim 2 wherein said second co-blowing agent comprises isobutane.

6. The blowing agent of claim 2 wherein said second co-blowing agent comprises methyl formate.

7. The blowing agent of claim 2 wherein first co-blowing agent comprises isobutane and wherein said second co-blowing agent comprises methyl formate.

8. The blowing agent of claim 2 wherein first co-blowing agent comprises isobutane and wherein said second co-blowing agent comprises methyl formate.

9. The blowing agent of claim 2 wherein first co-blowing agent comprises isobutane and wherein said second co-blowing agent comprises ethanol.

10. A blowing agent for producing extruded polystyrene foam having low aged lambda and low foam density, said blowing agent comprising:
(a) from about 45% by weight to about 65% by weight of a combination of 1234ze(E) and 1233zd(E);
(b) a first co-blowing agent consisting essentially of from about 5% to about 15% by weight of methyl formate, ethanol and combinations of these;
(c) a second co-blowing agent consisting essentially of from about 25% to about 40% by weight of isobutane; and
(d) a third co-blowing agent consisting essentially of from about 3% to about 5% by weight of carbon dioxide.

11. The blowing agent of claim 10 wherein said first co-blowing agent consisting essentially of from about 5% to about 15% by weight of methyl formate.

12. The blowing agent of claim 11 wherein said second co-blowing agent consisting essentially of from about 30% to about 40% by weight of isobutane.

13. The blowing agent of claim 10 wherein said first co-blowing agent consisting essentially of from about 5% to about 15% by weight of ethanol.

14. The blowing agent of claim 13 wherein said second co-blowing agent consisting essentially of from about 30% to about 40% by weight of isobutane.

15. The blowing agent of claim 10 wherein said blowing agent comprises:
(a1) from about 30% by weight to about 50% by weight of 1234ze(E);
(a2) from about 10% by weight to about 20% by weight of 1233zd(E);
(b) about 5% to about 20% by weight of methyl formate, ethanol and combinations of these;
(c) about 20% to about 40% by weight of dimethyl ether, isobutane and combinations of these; and
(d) about 3% to about 5% by weight of carbon dioxide, provided that the (a1), (a2), (b), (c) and (d) together comprise at least about 97% by weight of the blowing agent.

16. The blowing agent of claim 2 wherein said blowing agent comprises:
(a1) about 40% by weight of 1234ze(E);
(a2) about 13% by weight of 1233zd(E);
(b) about 10% by weight of methyl formate;
(c) about 33% by weight of isobutane; and
(d) about 3% to about 5% by weight of carbon dioxide, provided that the (a1), (a2), (b), (c) and (d) together comprise at least about 97% by weight of the blowing agent.

17. The blowing agent of claim 2 wherein said blowing agent comprises:
(a1) from about 30% by weight to about 50% by weight of 1234ze(E);
(a2) from about 10% by weight to about 20% by weight of 1233zd(E);
(b) about 5% to about 15% by weight of ethanol;
(c) about 30% to about 40% by weight of isobutane; and
(d) about 3% to about 5% by weight of carbon dioxide.

18. The blowing agent of claim 2 wherein said blowing agent comprises:
(a1) about 41.5% by weight of 1234ze(E);
(a2) about 10% by weight of 1233zd(E);
(b) about 7% by weight of ethanol;
(c) about 35% by weight of isobutane; and
(d) about 3% to about 5% by weight of carbon dioxide.

19. The blowing agent of claim 2 wherein said blowing agent comprises:
(a1) about 40% by weight of 1234ze(E);
(a2) about 13% by weight of 1233zd(E);
(b) about 10% by weight of ethanol;
(c) about 33% by weight of isobutane; and
(d) about 3% to about 5% by weight of carbon dioxide.

20. The blowing agent of claim 1 wherein said blowing agent comprises:
(a) from about 60% to about 65% by weight of 1234ze(E);
(b) from about 5% to about 15% by weight of methyl formate;
(c) from about 15% to about 35% by weight of isobutane; and
(d) about 3% to about 5% by weight of carbon dioxide.
